(19) United States
(12) Patent Application Publication
(10) Pub. No.: US 2026/0081041 A1
(43) Pub. Date: Mar. 19, 2026

(54) PULVERIZED COAL AND WARM NUCLEAR FUSION COMBINED GLOWING FLAME BURNER

(71) Applicant: Leading Guochuang (Beijing) Technology Group Co., LTD, Beijing (CN)

(72) Inventors: Enzhen Ding, Beijing (CN); Liwen Liu, Beijing (CN)

(21) Appl. No.: 19/396,357

(22) Filed: Nov. 21, 2025

(30) Foreign Application Priority Data
Aug. 29, 2025 (CN) 202511228716.1

(51) Int. Cl. G21B 3/00; C04B 7/44; F23D 1/00; F23D 99/00; F27B 15/00; F27D 99/00

(52) U.S. Cl. CPC G21B 3/00; C04B 7/44; F23D 1/00; F23D 99/004; F27B 15/00; F27D 99/0033; F27M 2003/03

(57) ABSTRACT

A pulverized coal and warm nuclear fusion combined glowing flame burner is provided, and relates to the field of cement production. The burner includes: a metal elbow; and a warm nuclear fusion excitation assembly, which includes a metal outer shell, a metal electrode, an insulation connector, and an electrode tip. The metal outer shell located inside the metal elbow is partially provided with an opening. The metal electrode is arranged inside the metal outer shell and is connected to the metal outer shell through the insulation connector. The metal outer shell is provided with a conveying pipe communicated to an inner cavity of the metal outer shell. A conveying channel is arranged in the metal electrode, and one end of the conveying channel penetrates through an outer side wall of a first end of the metal electrode to form an air outlet.

### TECHNICAL FIELD

The present disclosure relates to the technical field of cement production, and specifically to a pulverized coal and warm nuclear fusion combined glowing flame burner of a cement production decomposing furnace.

### BACKGROUND

In cement production, the formation of clinker involves six stages: At 100-150° C., free moisture in a raw material entering a kiln is evaporated. At 450° C., kaolinite in clay is dehydrated to release crystalline water. At 600° C., magnesium carbonate begins to be decomposed (a maximum rate is achieved at 750° C.). At 800° C., calcium carbonate starts to be decomposed (a maximum rate is achieved at 900° C.). At 800-1300° C., solid-phase reactions occur sequentially, thus forming CA, CF, C₂S, C₃A, and C₄AF. At 1300-1450° C. and during cooling to 1300° C., C₂S reacts with remaining CaO to form key C₃S. Below 1300° C., a cooling process begins. Rapid cooling is required to prevent C₂S from being transformed into non-hydrated γ-C₂S. During production, grinding the raw material enlarges a specific surface area of the raw material, thereby improving the high-temperature reaction efficiency. Grinding the clinker increases a specific surface area of the clinker to accelerate hydration reactions. Core energy-consuming equipment in the entire process is a decomposing furnace (in which pulverized coal is burnt in glowing flames) and a rotary kiln (in which pulverized coal is burnt in open flames), with a coal ratio of 60:40. Heat is provided by burning of high-calorific-value pulverized anthracite.

In a traditional process, the decomposing furnace is connected to a preheater and a rotary kiln. The decomposing furnace primarily relies on high-temperature flue gas (typically 800-1000°C.) discharged from a kiln tail of the rotary kiln and heat brought in by a preheated raw material to maintain a 800-900° C. high-temperature environment inside the furnace to implement spontaneous ignition of pulverized coal. This temperature far exceeds an ignition point of 400-500° C. of the pulverized coal.

However, this method of maintaining burning based on factors such as the temperature of the flue gas from the kiln tail and the heat brought in by the raw material, so that the stability is easily affected by fluctuation. During starting, under a low load, or during kiln condition fluctuation, problems of poor burning of the pulverized coal and even flameout easily occur.

### SUMMARY

The present disclosure aims to provide a pulverized coal and warm nuclear fusion combined glowing flame burner, and aims to solve the technical problems in the above background section.

The embodiments of the present disclosure are implemented below:

An embodiment of the present disclosure provides a pulverized coal and warm nuclear fusion combined glowing flame burner, including: a metal elbow; and a warm nuclear fusion excitation assembly, which includes a metal outer shell, a metal electrode, an insulation connector, and an electrode tip; the metal outer shell has a first end located inside the metal elbow and a second end located outside the metal elbow. The metal outer shell located inside the metal elbow is partially provided with an opening; the metal electrode is arranged inside the metal outer shell and is in insulation connection to the metal outer shell through the insulation connector; the metal electrode has a first end close to the opening and a second end for being electrically connected to a power source; the metal outer shell is provided with a conveying pipe communicated to an inner cavity of the metal outer shell; a conveying channel is arranged in the metal electrode, and one end of the conveying channel penetrates through an outer side wall of a first end of the metal electrode to form an air outlet; the electrode tip is arranged at the air outlet; the electrode tip is provided with a flow guide through hole; the flow guide through hole is communicated with the conveying channel; and one end of the conveying channel that is away from the electrode tip is communicated with an air supply valve group.

Further, based on the foregoing solution, the metal elbow includes a first straight pipe portion connected to a decomposing furnace, and further includes a second straight pipe portion for inputting pulverized wind-coal.

The metal outer shell includes: a first annular steel tube, where one end of the first annular steel tube extends into the first straight pipe portion and is arranged in an axial direction of the first straight pipe portion, and another end of the first annular steel tube penetrates through to an exterior of the metal elbow; a second annular steel tube, which is docked to a port portion of the first annular steel tube outside the metal elbow; and a protective hood, which is in seal fit with a port of the second annular steel tube that is away from the first annular steel tube; a port of the first annular steel tube that is away from the second annular steel tube is an opening; and the metal electrode is located inside a cavity enclosed by the first annular steel tube, the second annular steel tube, and the protective hood.

Further, based on the foregoing solution, a straight pipe communicated with an inner cavity of the metal elbow is arranged on an outer side wall of the metal elbow; and the straight pipe is configured to allow the first annular steel tube to be inserted.

The second annular steel tube is detachably connected to the straight pipe through a flange structure.

Further, based on the foregoing solution, an exterior of the first annular steel tube is sleeved with a ceramic protective pipe.

Further, based on the foregoing solution, the insulation connector includes: an insulation base, which is arranged at one end of the metal electrode that is away from the electrode tip; and an insulation protective sleeve, which is sleeved at a periphery of the metal electrode between the insulation base and the electrode tip.

Further, based on the foregoing solution, a mounting through hole for mounting the metal electrode is formed in the insulation base; a visible through hole is formed in the insulation base outside the mounting through hole; a transparent blocking piece is arranged in the visible through hole; an observation window is arranged on the protective hood; and the observation window is opposite to the transparent blocking piece.

Further, based on the foregoing solution, the metal electrode is rotatably sleeved with a cyclone blade; and the cyclone blade is located between a position, at which the conveying pipe is communicated with the metal outer shell, and the electrode tip.

Further, based on the foregoing solution, a heat-resistant stainless steel pipe section is arranged on an inner side wall of the first annular steel tube, and the electrode tip is located inside the heat-resistant stainless steel pipe section.

Further, based on the foregoing solution, a ceramic inner liner pipe is arranged inside the metal elbow.

Further, based on the foregoing solution, the metal outer shell is provided with a pressure detection head configured to detect an air pressure in the metal outer shell.

Compared with the existing art, the embodiments of the present disclosure at least has the following advantages or beneficial effects:

The dependency of a traditional process on the temperature of the flue gas from the kiln tail and the heat brought in by the raw material is broken through. By actively building a plasma field to ensure a burning condition, the burning stability during starting, under a low load, and during kiln condition fluctuation can be significantly improved, and problems of poor burning and flameout are effectively avoided. Meanwhile, combined release of nuclear energy and chemical energy significantly improves the energy utilization efficiency, and a significant energy enhancing and coal saving effect can be achieved.

### BRIEF DESCRIPTION OF THE DRAWINGS

For clearer descriptions of the technical solutions of the embodiments of the present disclosure, the accompanying drawings required to be used in the embodiments are briefly introduced below. It should be understood that the accompanying drawings below are only some embodiments of the present disclosure. Therefore, the embodiments shall not be regarded as limitations on the scope. A person of ordinary skill in the art can also derive other relevant drawings according to these drawings without creative work.

FIG. 1 is an axonometric drawing of a pulverized coal and warm nuclear fusion combined glowing flame burner according to an embodiment of the present disclosure;

FIG. 2 is an exploded view of a pulverized coal and warm nuclear fusion combined glowing flame burner according to an embodiment of the present disclosure;

FIG. 3 is a sectional view of a pulverized coal and warm nuclear fusion combined glowing flame burner according to an embodiment of the present disclosure;

FIG. 4 is a partially enlarged view of A in FIG. 3;

FIG. 5 is a partially enlarged view of B in FIG. 3;

FIG. 6 is a schematic structural diagram of a protective hood according to an embodiment of the present disclosure;

FIG. 7 is a first axonometric drawing of an insulation base according to an embodiment of the present disclosure;

FIG. 8 is a second axonometric drawing of an insulation base according to an embodiment of the present disclosure; and

FIG. 9 is an axonometric drawing of an electrode tip according to an embodiment of the present disclosure.

Reference numerals: 1: metal elbow; 2: ceramic inner liner pipe; 3: straight pipe; 4: metal outer shell; 401: first annular steel tube; 402: second annular steel tube; 403: protective hood; 5: air supply valve group; 6: conveying pipe; 7: flange structure; 8: electrode tip; 9: heat-resistant stainless steel pipe section; 10: flow guide through hole; 11: metal electrode; 12: conveying channel; 13: cyclone blade; 14: insulation protective sleeve; 15: insulation base; 16: pressure detection head; 17: observation window; 18: visible through hole; 19: transparent blocking piece; and 20: ceramic protective pipe.

### DETAILED DESCRIPTION OF THE EMBODIMENTS

The embodiments of the present disclosure are described in detail below with reference to the accompanying drawings in the embodiments of the present disclosure.

### Embodiment

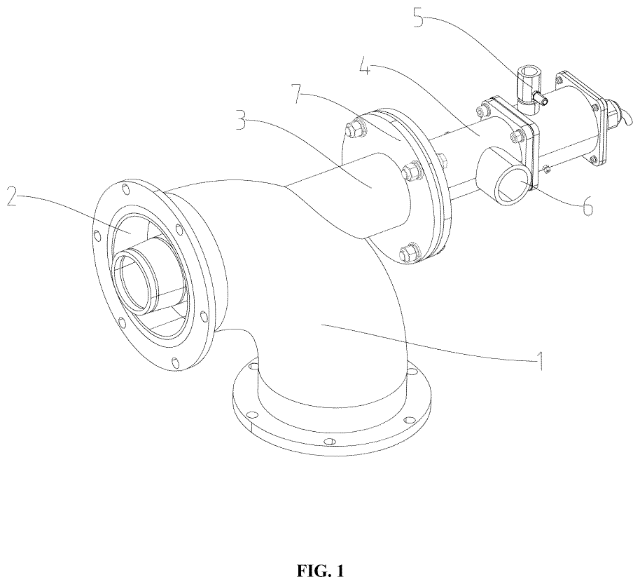

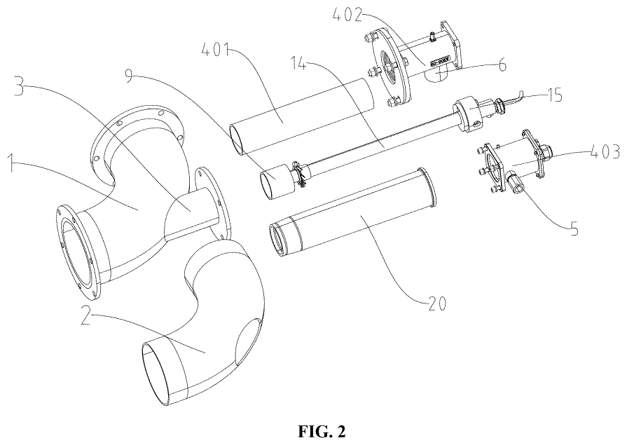

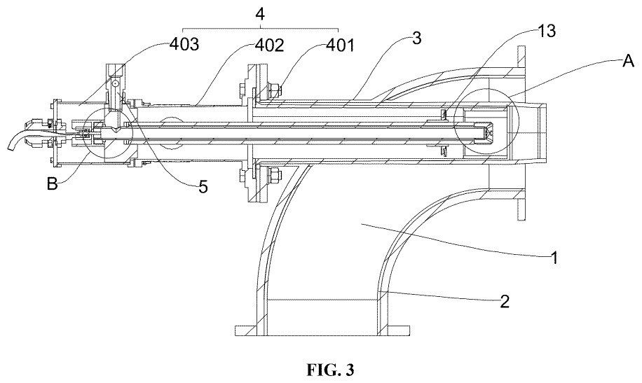

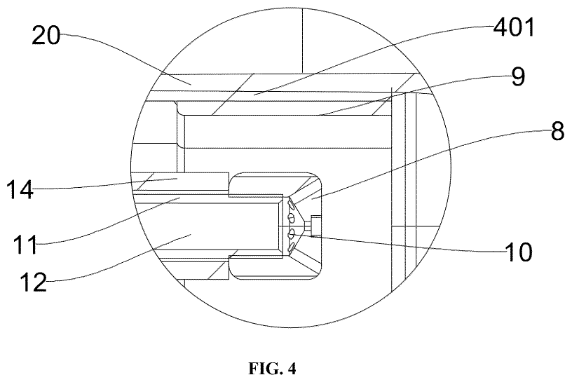

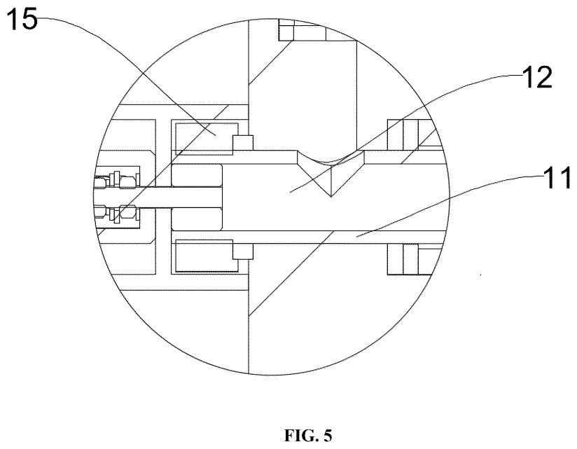

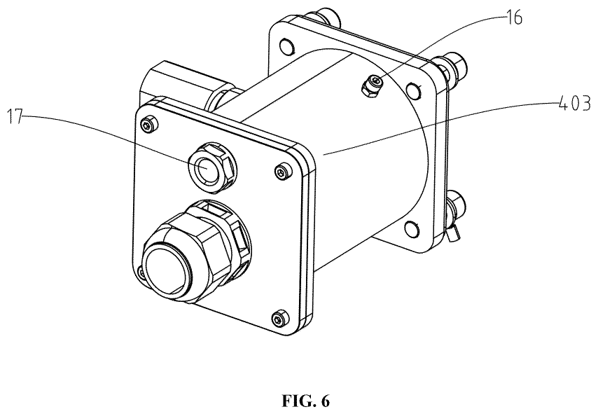

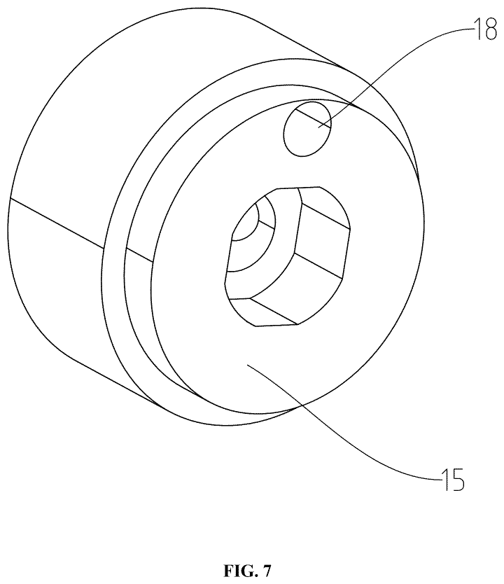

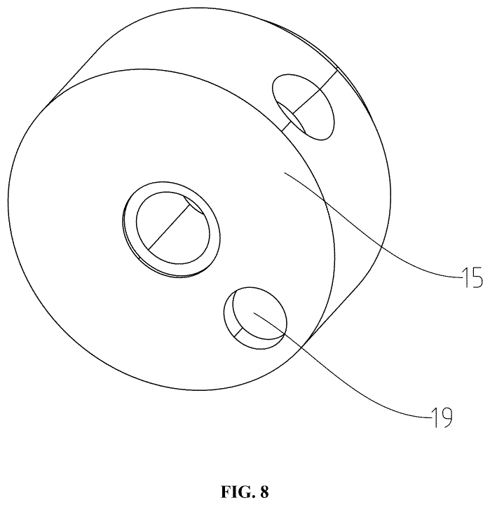

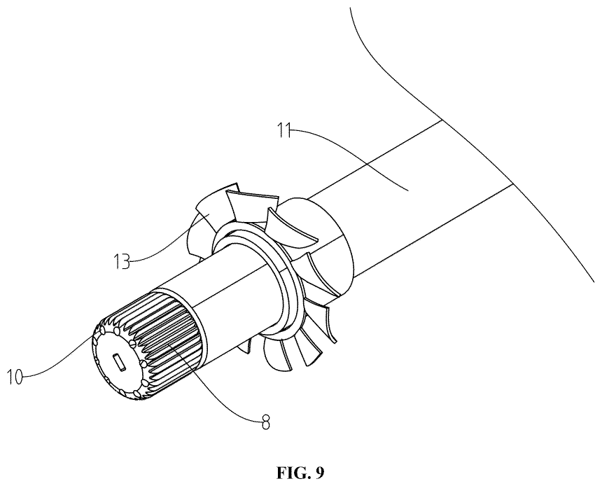

Referring to FIG. 1 to FIG. 9, an embodiment of the present disclosure provides a pulverized coal and warm nuclear fusion combined glowing flame burner, including: a metal elbow 1 (which is made of a steel material); and a warm nuclear fusion excitation assembly, which includes a metal outer shell 4, a metal electrode 11, an insulation connector, and an electrode tip 8; the metal outer shell 4 has a first end located inside the metal elbow 1 and a second end located outside the metal elbow 1. The metal outer shell 4 located inside the metal elbow 1 is partially provided with an opening. The metal electrode 11 is arranged inside the metal outer shell 4 and is in insulation connection to the metal outer shell 4 through the insulation connector. The metal electrode 11 has a first end close to the opening and a second end for being electrically connected to a power source. The metal outer shell 4 is provided with a conveying pipe 6 communicated to an inner cavity of the metal outer shell 4. A conveying channel 12 is arranged in the metal electrode 11, and one end of the conveying channel 12 penetrates through an outer side wall of a first end of the metal electrode 11 to form an air outlet. The electrode tip 8 is arranged at the air outlet. The electrode tip 8 is provided with a flow guide through hole 10. The flow guide through hole 10 is communicated with the conveying channel 12. One end of the conveying channel 12 that is away from the electrode tip 8 is communicated with an air supply valve group 5.

A working principle of the pulverized coal and warm nuclear fusion combined glowing flame burner is as follows: The metal electrode 11 is connected to a 1 kHz-50 kHz, 5 kV-50 kV warm nuclear fusion excitation power source with a sudden drop characteristic. Two ends of the metal elbow 1 are respectively connected to the decomposing furnace and a pulverized wind-coal source. Organic gas such as air, water vapor, hydrogen, or ammonia gas is fed by the air supply valve group 5, and burning-supporting air is supplied by the conveying pipe 6. Air of the conveying pipe 6 implements glowing flame burning on pulverized wind-coal in the decomposing furnace to release chemical energy. Meanwhile, the electrode tip 8 cooperates with the metal outer shell 4 to form a diverging high-frequency alternating plasma field with gradually changing gradients (in a direction from the electrode tip 8 to an interior of the decomposing furnace). This field excites deuterium and tritium that are hydrogen isotopes in the pulverized coal, the air, and the water vapor to undergo a fusion reaction to release nuclear energy, thus finally implementing synergistic release and combined burning of the nuclear energy and the chemical energy. The significant advantage is that the dependency of a traditional process on the temperature of the flue gas from the kiln tail and the heat brought in by the raw material is broken through. By actively building a plasma field to ensure a burning condition, the burning stability during starting, under a low load, and during kiln condition fluctuation can be significantly improved, and problems of poor burning and flameout are effectively avoided. Meanwhile, combined release of nuclear energy and chemical energy significantly improves the energy utilization efficiency, and a significant energy enhancing and coal saving effect can be achieved.

Optionally, a concentration of the pulverized wind-coal fed into the metal elbow 1 is 0.8-8 kg (pulverized coal)/kg (air) (i.e. every kg of air conveys 0.8-8 kg of pulverized coal in a suspended manner). The pulverized coal feeding amount is 2-10 tons/h. The air fed by the conveying pipe 6 is 10-60 cubic meters/h. It ensures that the pulverized coal in a nozzle of the decomposing furnace docked to the metal elbow 1 can excite deuterium and tritium fusion in the plasma field to release the nuclear energy. Then, the pulverized wind-coal enters the decomposing furnace for glowing flame burning.

One end of the flow guide through hole 10 is communicated with the above conveying channel 12, and another end of the flow guide through hole 10 penetrates through a side surface of the electrode tip 8 that is away from the metal electrode 11. A plurality of flow guide through holes 10 are provided, which are uniformly arranged in a spacing manner in a circumferential direction of the electrode tip 8. An outer ring surface of the electrode tip 8 partially protrudes to form a plurality of discharging portions. The plurality of discharging portions are uniformly distributed in a spacing manner in the circumferential direction of the electrode tip 8. The plurality of flow guide through holes 10 are uniformly formed in the side surface of the electrode tip 8 that is away from the metal electrode 11, so that dielectric gas (air, water vapor, and the like) in the conveying channel 12 is uniformly sprayed out in the circumferential direction and is fully mixed with the pulverized wind-coal flowing therethrough. Meanwhile, the plurality of discharging portions on the outer ring surface of the electrode tip 8 are uniformly distributed in the circumferential direction. A discharging effect of a pointed end of a protruding structure enhances the intensity of a local electric field, so that mixed media are more easily ionized. The uniform high-frequency alternating plasma field with a large coverage range is formed between the electrode tip 8 and the grounding electrode, thus efficiently exciting the hydrogen isotopes to undergo a synergistic reaction of warm nuclear fusion and pulverized coal glowing flame burning. The advantages are as follows: the uniform arrangement of the flow guide through holes 10 ensures the mixing uniformity of the dielectric gas and the pulverized wind-coal and avoids imbalance of local reactions. The circumferential uniform distribution of the discharging portions improves the consistency of the intensity of the electric field, improves the stability and coverage efficiency of the plasma field, and promotes full release of the nuclear energy and the chemical energy. Meanwhile, this optimizes the energy distribution of the electrode tip 8 and prolongs the service life of the electrode tip 8. This further ensures the efficient and stable operation of a burning system.

It is worth noting that as an extremely innovative energy utilization technology, a chemical energy and nuclear energy combined burning technology ingeniously organically fuses a process of burning traditional chemical fuel to release chemical energy with a process of releasing nuclear energy by nuclear reactions, to devote to create a more efficient, cleaner, and more stable energy supply mode. In this technical system, the high-frequency high-voltage electric field provides energy for igniting the initial chemical fuel and also creates a specific reaction environment, so that high-energy particles, i.e. deuterium and tritium, in the fuel undergo fusion to release the nuclear energy which is released at the same time that the chemical energy is released. Meanwhile, the energy released by the nuclear energy can further improve the combustion efficiency of the chemical fuel, thereby effectively reducing the consumption of the chemical fuel and the emission of pollutants. By combining the chemical energy and the nuclear energy, the inherent limitations of relying on a single energy source have been successfully overcome. The chemical energy and nuclear energy combined burning technology belongs to common knowledge, and has been disclosed in the book Theory and Application of Controllable Warm Nuclear Fusion Accompanied by Photonuclear Reaction Burning ISBN978-7-5646-5429-0. The book was co-authored by Ding Enzhen, Liu Angang, et al., and was published by China University of Mining and Technology Press in June 2022.

In a preferred implementation, the metal elbow 1 includes a first straight pipe portion connected to a decomposing furnace, and further includes a second straight pipe portion for inputting pulverized wind-coal.

The metal outer shell 4 includes: a first annular steel tube 401, where one end of the first annular steel tube 401 extends into the first straight pipe portion and is arranged in an axial direction of the first straight pipe portion, and another end of the first annular steel tube 401 penetrates through to an exterior of the metal elbow 1; a second annular steel tube 402, which is docked to a port portion of the first annular steel tube 401 outside the metal elbow 1; and a protective hood 403, which is in seal fit with a port of the second annular steel tube 402 that is away from the first annular steel tube 401; a port of the first annular steel tube 401 that is away from the second annular steel tube 402 is an opening; and the metal electrode 11 is located inside a cavity enclosed by the first annular steel tube 401, the second annular steel tube 402, and the protective hood 403.

In the above embodiment, the pulverized wind-coal is fed into the second straight pipe portion of the metal elbow 1, while the first straight pipe portion is connected to the decomposing furnace. The pulverized wind-coal flows to the decomposing furnace along the axis of the first straight pipe portion. The metal electrode 11 is connected to the 1 kHz-50 kHz, 5 kV-50 kV warm nuclear fusion excitation power source with the sudden drop characteristic to form the high-frequency high-voltage electric field together with the first annular steel tube 401 (used as a grounding electrode) extending into the first straight pipe portion. An opening of the first annular steel tube 401 faces a pulverized wind-coal flowing path and cooperates with the sealed cavity enclosed by the second annular steel tube 402 and the protective hood 403 to cause the dielectric gas (the air, the water vapor, and the like) to be ionized in the electric field, thus forming the diverging high-frequency alternating plasma field extending along the axis of the first straight pipe portion. When the pulverized wind-coal flows through this field, the hydrogen isotopes in the pulverized wind-coal undergo warm nuclear fusion under the excitation of the electric field to release the nuclear energy. Meanwhile, the pulverized coal releases the chemical energy during glowing flame burning. Thus, combined burning is implemented. The advantage is as follows: the annular steel tube 401 is arranged along the axis of the first straight pipe portion, which ensures precise alignment between the plasma field and the flowing direction of the pulverized wind-coal, thereby improving the energy conversion efficiency. The segmented design of the metal outer shell 4 facilitates the mounting and maintenance, and the seal fit of the protective hood 403 effectively protects internal components from being worn by the pulverized coal. The opening directly interacts with the pulverized wind-coal that enters the decomposing furnace, to enhance the synergistic release effect of the nuclear energy and the chemical energy, further improving the burning stability, and contributing to achieving the goal of energy enhancing and coal saving.

In a preferred implementation, a straight pipe 3 communicated to an inner cavity of the metal elbow 1 is arranged on an outer side wall of the metal elbow 1, and the straight pipe 3 is configured to allow the first annular steel tube 401 to be inserted.

The second annular steel tube 402 is detachably connected to the straight pipe 3 through a flange structure 7.

In the above embodiment, the straight pipe 3 on the outer side wall of the metal elbow 1 is communicated to the inner cavity of the metal elbow 1, to allow the first annular steel tube 401 to be inserted, so that the opening of the first annular steel tube 401 is precisely located in the pulverized wind-coal flowing path in the inner cavity of the metal elbow 1. The second annular steel tube 402 is detachably connected to the straight pipe 3 through the flange structure 7, which not only fixes the position of the first annular steel tube 401, but also forms a sealed space, to ensure stable generation of the high-frequency high-voltage electric field between the metal electrode 11 and the first annular steel tube 401. The advantage is as follows: the detachable connection implemented by the flange facilitates the mounting, maintenance, and replacement of components such as the first annular steel tube 401 and the metal electrode 11 and meets the on-site modification requirement of the decomposing furnace. The straight pipe (3) provides a stable support for the first annular steel tube (401), to ensure precise interactions between the opening and the pulverized wind-coal flowing path, improve the contact efficiency between the plasma field and the pulverized wind-coal, and improve the synergistic release effect on the nuclear energy and the chemical energy. This further ensures the burning stability and contributes to achieving energy enhancing and coal saving.

In a preferred implementation, an exterior of the first annular steel tube 401 is sleeved with a ceramic protective pipe.

In the above embodiment, a ceramic material has excellent wear resistance and high-temperature resistance, which effectively withstand scouring wear during conveying of the pulverized wind-coal and the high-temperature environment inside the decomposing furnace. This protects the first annular steel tube (401) from being damaged and prolongs its service life. Meanwhile, the insulation characteristic of the ceramic can reduce the energy loss of the electric field, thus ensuring the stable formation of the high-frequency high-voltage electric field between the first annular steel tube 401 and the metal electrode 11, thereby ensuring that the plasma field always works.

In a preferred implementation, the insulation connector includes: an insulation base 15, which is arranged at one end of the metal electrode 11 that is away from the electrode tip 8; and an insulation protective sleeve 14, which is sleeved at a periphery of the metal electrode 11 between the insulation base 15 and the electrode tip 8.

In the above embodiment, the insulation base 15 is arranged at the end of the metal electrode 11 that is away from the electrode tip 8. The insulation protective sleeve 14 is sleeved at the periphery of the metal electrode 11 between the insulation base 15 and the electrode tip 8. By their synergistic effect, reliable insulation between the metal electrode 11 and the metal outer shell 4 is implemented, and leakage of high-frequency high-voltage current or a short circuit is avoided. The advantage is as follows: a region in which the metal electrode 11 may be in contact with the outer shell is comprehensively covered, thus ensuring stable insulation between the electrode and the outer shell, and providing a reliable support for the generation of the high-frequency high-voltage electric field. Meanwhile, the insulation material can protect the metal electrode 11 from being corroded and worn by the dielectric gas and the pulverized coal, thus improving the overall stability of equipment and prolonging the service life.

In a preferred implementation, a mounting through hole for mounting the metal electrode 11 is formed in the insulation base 15. A visible through hole 18 is formed in the insulation base 15 outside the mounting through hole. A transparent blocking piece 19 is arranged in the visible through hole 18. An observation window 17 is arranged on the protective hood 403. The observation window 17 is opposite to the transparent blocking piece 19.

In the above embodiment, an observation passage for directly observing the interior without disassembling the equipment is formed by oppositely arranging the visible through hole 18 (in which the transparent blocking piece 19 is arranged) on the insulation base 15 and the observation window 17 of the protective hood 403. This is convenient for real-time monitoring of a state (for example, a form and stability) of the high-frequency alternating plasma field near the metal electrode 11 and the electrode tip 8, thus providing an intuitive basis for promptly determining whether a burning reaction functions normally. Meanwhile, the transparent blocking piece 19 can ensure observation clarity while effectively sealing the through hole, to prevent leakage of internal dielectric gas (air, water vapor, and the like) and intrusion of external pulverized coal and dust. This ensures the sealing property of the insulation base 15 and the cleanliness of the internal components, and ensures the stability of the insulation performance. In addition, this design simplifies a monitoring process for a core region of burning, reduces a frequency of shutdown inspection, improves the operational continuity and maintenance efficiency of the equipment, and helps optimize operating parameters through real-time observation, and further ensures the high efficiency and stability of the combined burning.

In a preferred implementation, the metal electrode 11 is rotatably sleeved with a cyclone blade 13. The cyclone blade 13 is located between a position, at which the conveying pipe 6 is communicated with the metal outer shell 4, and the electrode tip 8.

In the above embodiment, the rotatable cyclone blade 13 on the metal electrode 11 is located between the position, at which the conveying pipe 6 (which feeds combustion-supporting air) is communicated with the metal outer shell 4, and the electrode tip 8. When the combustion-supporting air fed by the conveying pipe 6, the pulverized wind-coal inside the metal outer shell 4, and other media (such as the organic gas) flow through this part, the cyclone blade 13 rotates under the pushing of the media to cause the mixed media to form a strong cyclone. After the mixing of the constituents is enhanced, the mixed media flow to the region of the electrode tip 8 and the plasma field.

The advantage is as follows: the cyclone effect significantly improves the mixing uniformity of the combustion-supporting air, the pulverized wind-coal, and the dielectric gas, and avoids local concentration imbalance that may affect the burning efficiency. Meanwhile, the cyclone flow prolongs the residence time of the mixed media in the plasma field, enlarges a contact area with the high-frequency alternating plasma field, and enhances the interaction strength of the high-frequency alternating plasma field. This more efficiently excites the warm nuclear fusion of the hydrogen isotope and the glowing flame burning of the pulverized coal, thereby strengthening the synergistic release of the nuclear energy and the chemical energy. In addition, the cyclone can reduce deposition and blockage of the pulverized coal in pipeline, and the rotatable characteristic of the blade can adapt to varying medium flow rates, thus improving the adaptability to working condition fluctuations and further ensuring the burning stability and the energy enhancing and coal saving effect.

In a preferred implementation, a heat-resistant stainless steel pipe section 9 is arranged on an inner side wall of the first annular steel tube 401, and the electrode tip 8 is located inside the heat-resistant stainless steel pipe section 9.

In the above embodiment the heat-resistant stainless steel pipe section 9 itself has excellent conductivity, high-temperature resistance, and corrosion resistance, adapts to harsh environments inside the decomposing furnace, including a high temperature (800-900° C.), pulverized coal scouring, and burning corrosion. It can stably achieve a grounding function for a long time, thus avoiding the degradation of the conductivity caused by high-temperature oxidation or wear in a traditional grounding electrode.

In a preferred implementation, a ceramic inner liner pipe 2 is arranged inside the metal elbow 1.

In the above embodiment, the ceramic inner liner pipe 2 is arranged inside the metal elbow 1, and can withstand pulverized wind-coal scouring by excellent wear resistance of ceramic, protect the metal elbow 1, and prolong the service life of the metal elbow 1.

In a preferred implementation, the metal outer shell 4 is provided with a pressure detection head 16 configured to detect an air pressure in the metal outer shell 4.

In the above embodiment, the metal outer shell 4 is provided with the pressure detection head 16, so that it can monitor the air pressure inside in real time to promptly identify abnormalities and ensure safe operation of the equipment as well as stable conveying of the media.

Moreover, unless otherwise explicitly defined or limited, in the embodiments of the present disclosure, the terms “mount” and “connect” shall be interpreted broadly. For instance, “connect” may refer to either detachable or non-detachable connection, direct connection, or indirect connection via an intermediate medium. If directional terms such as “upper,” “lower,” “left,” “right,” “inner,” “outer,” and “side” are used, they refer only to the orientations shown in the accompanying drawings or conventional placement orientations during product use. These terms are merely intended for clear description of the present disclosure and do not indicate or imply that a specified device or element needs to have a particular orientation and be constructed and operated in the particular orientation, so that these terms are not construed as limiting the present disclosure. In addition, the terms “first”, “second”, and the like are only for the purpose of distinguishing, and may not be understood as indicating or implying the relative importance. “Plurality” refers to at least two. In the embodiments of the present disclosure, relative positional relationships such as being parallel, being perpendicular, and being aligned mentioned are all defined relative to a current technical level, rather than absolutely strict limitation. Minor errors are permitted, allowing for being approximately parallel, being approximately perpendicular, being approximately aligned, and the like. For example, when A is parallel to B, it means that A and B are parallel or approximately parallel, with an angle between A and B ranging from 0 to 10 degrees.

The foregoing embodiments are merely some embodiments and implementations of the present disclosure, and are not intended to limit the protection scope of the present disclosure. Without conflicts, the embodiments of the present disclosure and features in the embodiments can be combined with each other. Arbitrary combination of the features in different embodiments also falls within the protection scope of the present disclosure. Changes or replacements that any person skilled in the art can easily think of within the technical range disclosed in the present disclosure all fall within the protection scope of the present disclosure.

What is claimed is:

1. A pulverized coal and warm nuclear fusion combined glowing flame burner, comprising:
a metal elbow (1); and
a warm nuclear fusion excitation assembly, which comprises a metal outer shell (4), a metal electrode (11), an insulation connector, and an electrode tip (8);
the metal outer shell (4) has a first end located inside the metal elbow (1) and a second end located outside the metal elbow (1), wherein the metal outer shell (4) located inside the metal elbow (1) is partially provided with an opening;
the metal electrode (11) is arranged inside the metal outer shell (4) and is in insulation connection to the metal outer shell (4) through the insulation connector; the metal electrode (11) has a first end close to the opening and a second end for being electrically connected to a power source;
the metal outer shell (4) is provided with a conveying pipe (6) communicated to an inner cavity of the metal outer shell; a conveying channel (12) is arranged in the metal electrode (11), and one end of the conveying channel (12) penetrates through an outer side wall of a first end of the metal electrode (11) to form an air outlet; the electrode tip (8) is arranged at the air outlet; the electrode tip (8) is provided with a flow guide through hole (10); the flow guide through hole (10) is communicated with the conveying channel (12); and
one end of the conveying channel (12) that is away from the electrode tip (8) is communicated with an air supply valve group (5).

2. The pulverized coal and warm nuclear fusion combined glowing flame burner according to claim 1, wherein the metal elbow (1) comprises a first straight pipe portion connected to a decomposing furnace, and further comprises a second straight pipe portion for inputting pulverized wind-coal;
the metal outer shell (4) comprises:
a first annular steel tube (401), wherein one end of the first annular steel tube (401) extends into the first straight pipe portion and is arranged in an axial direction of the first straight pipe portion, and another end of the first annular steel tube (401) penetrates through to an exterior of the metal elbow (1);
a second annular steel tube (402), which is docked to a port portion of the first annular steel tube (401) outside the metal elbow (1); and
a protective hood (403), which is in seal fit with a port of the second annular steel tube (402) that is away from the first annular steel tube (401);
a port of the first annular steel tube (401) that is away from the second annular steel tube (402) is an opening; and the metal electrode (11) is located inside a cavity enclosed by the first annular steel tube (401), the second annular steel tube (402), and the protective hood (403).

3. The pulverized coal and warm nuclear fusion combined glowing flame burner according to claim 2, wherein a straight pipe (3) communicated with an inner cavity of the metal elbow (1) is arranged on an outer side wall of the metal elbow (1); and the straight pipe (3) is configured to allow the first annular steel tube (401) to be inserted; and
the second annular steel tube (402) is detachably connected to the straight pipe (3) through a flange structure (7).

4. The pulverized coal and warm nuclear fusion combined glowing flame burner according to claim 2, wherein an exterior of the first annular steel tube (401) is sleeved with a ceramic protective pipe (20).

5. The pulverized coal and warm nuclear fusion combined glowing flame burner according to claim 2, wherein the insulation connector comprises:
an insulation base (15), which is arranged at one end of the metal electrode (11) that is away from the electrode tip (8); and
an insulation protective sleeve (14), which is sleeved at a periphery of the metal electrode (11) between the insulation base (15) and the electrode tip (8).

6. The pulverized coal and warm nuclear fusion combined glowing flame burner according to claim 5, wherein a mounting through hole for mounting the metal electrode (11) is formed in the insulation base (15); a visible through hole (18) is formed in the insulation base (15) outside the mounting through hole; a transparent blocking piece (19) is arranged in the visible through hole (18);
an observation window (17) is arranged on the protective hood (403); and the observation window (17) is opposite to the transparent blocking piece (19).

7. The pulverized coal and warm nuclear fusion combined glowing flame burner according to claim 1, wherein the metal electrode (11) is rotatably sleeved with a cyclone blade (13); and the cyclone blade (13) is located between a position, at which the conveying pipe (6) is communicated with the metal outer shell (4), and the electrode tip (8).

8. The pulverized coal and warm nuclear fusion combined glowing flame burner according to claim 2, wherein a heat-resistant stainless steel pipe section (9) is arranged on an inner side wall of the first annular steel tube (401), and the electrode tip (8) is located inside the heat-resistant stainless steel pipe section (9).

9. The pulverized coal and warm nuclear fusion combined glowing flame burner according to claim 1, wherein a ceramic inner liner pipe (2) is arranged inside the metal elbow (1).

10. The pulverized coal and warm nuclear fusion combined glowing flame burner according to claim 1, wherein the metal outer shell (4) is provided with a pressure detection head (16) configured to detect an air pressure in the metal outer shell (4).
